(19) United States
(12) Patent Application Publication
(10) Pub. No.: US 2025/0170601 A1
(43) Pub. Date: May 29, 2025

(54) Refillable Dispenser Case

(71) Applicant: Pik Yung Teresa WU, Kowloon Bay (HK)

(72) Inventor: Pik Yung Teresa WU, Kowloon Bay (HK)

(21) Appl. No.: 18/522,273

(22) Filed: Nov. 29, 2023

(51) Int. Cl. B05B 11/10; B05B 11/00; B05B 11/02

(52) U.S. Cl. CPC B05B 11/1049; B05B 11/028; B05B 11/0097

(57) ABSTRACT

A refillable dispenser case includes an outer base rotatably connected to an outer cover; a cup received within and slidably coupled to the outer base; the outer cover has a lower portion which extends within the outer base and sleeves around an upper portion of the cup, and the lower portion of the outer cover is provided with at least one slanted sliding groove, each of which engages with a corresponding protrusion protruded outwards from the cup; a bottle inserted in the cup and having a dispensing outlet at an upper portion thereof; rotation of the outer base relative to the outer cover simultaneously rotates the cup and drives the protrusion of the cup to move along the corresponding slanted sliding groove and thereby driving the cup to slide axially relative to the outer base between a retracted position and an extended position.

### BACKGROUND OF THE INVENTION

The present invention relates to a refillable dispenser case for dispensing contents such as liquid contents from a container which stores the contents.

Dispensers which use a swivel-up mechanism to expose the dispensing outlet are widely available in the prior art, such as the cosmetic container disclosed in U.S. Pat. No. 9,277,797. However, such dispensers are complicated in structure and thus results in high manufacturing costs.

### BRIEF SUMMARY OF THE INVENTION

In view of the aforesaid disadvantages now present in the prior art, it is an object of the present invention to provide a refillable dispenser case which is simple in structure and thus capable of saving manufacturing costs.

To attain this, the present invention provides a refillable dispenser case comprising an outer base rotatably connected to an outer cover; a cup received within and slidably coupled to the outer base; the outer cover has a lower portion which extends within the outer base and sleeves around an upper portion of the cup, and the lower portion of the outer cover is provided with at least one slanted sliding groove, each of the at least one slanted sliding groove engages with a corresponding protrusion protruded outwards from the upper portion of the cup; a bottle inserted in the cup and having a dispensing outlet at an upper portion thereof; rotation of the outer base relative to the outer cover simultaneously rotates the cup and drives the protrusion of the cup to move along the corresponding slanted sliding groove and thereby driving the cup to slide axially relative to the outer base between a retracted position at which the dispensing outlet of the bottle is not exposed from the outer cover and an extended position at which the dispensing outlet of the bottle is protruded outward from the outer cover.

Particularly, the outer base is provided with at least one guiding groove, each of the at least one guiding groove engages with a corresponding guiding rib protruded outwards from a lower portion of the cup.

Particularly, the bottle is releasably inserted in the cup.

Particularly, the cup is provided with at least one elastic arc portion which is convex inwards so as to releasably retain the bottle in the cup.

Particularly, each of the slanted sliding grooves comprises a lower horizontal section, a slanting section and an upper horizontal section, a first end of the lower horizontal section communicates with a lower end of the slanting section, and a first end of the upper horizontal section communicates with an upper end of the slanting section.

Particularly, each of the outer cover and the outer base has a tubular interior which are interconnected with each other.

Particularly, the lower portion of the outer cover has an annular rib for snap engagement with an annular groove in an inner surface of the outer base.

Particularly, the bottle comprises a bottle body, an upper end of the bottle body is coupled to a collar in which a pump engine is disposed; the dispensing outlet is disposed in an actuator and communicates with the pump engine; the actuator cooperates with the pump engine so that actuating the actuator activates the pump engine to pull a piston disposed in the bottle body upwards to discharge contents stored in the bottle body via the dispensing outlet.

Particularly, a top surface of the actuator flushes with a top end of the outer cover at the retracted position.

Particularly, a longitudinal slot is provided at the lower portion of the outer cover.

### BRIEF DESCRIPTION OF THE DRAWINGS

FIG. 1 is an exploded view of an embodiment of the present invention.

FIG. 2 is a sectional view of the embodiment as shown in FIG. 1 at the retracted position.

FIG. 3 is a sectional view of the embodiment as shown in FIG. 1 at the extended position.

FIG. 4 is a sectional view of the outer base of the embodiment as shown in FIG. 1.

FIG. 5 is a sectional view of the outer cover of the embodiment as shown in FIG. 1.

FIG. 6 is a sectional view of the bottle of the embodiment as shown in FIG. 1.

### DETAILED DESCRIPTION OF THE INVENTION

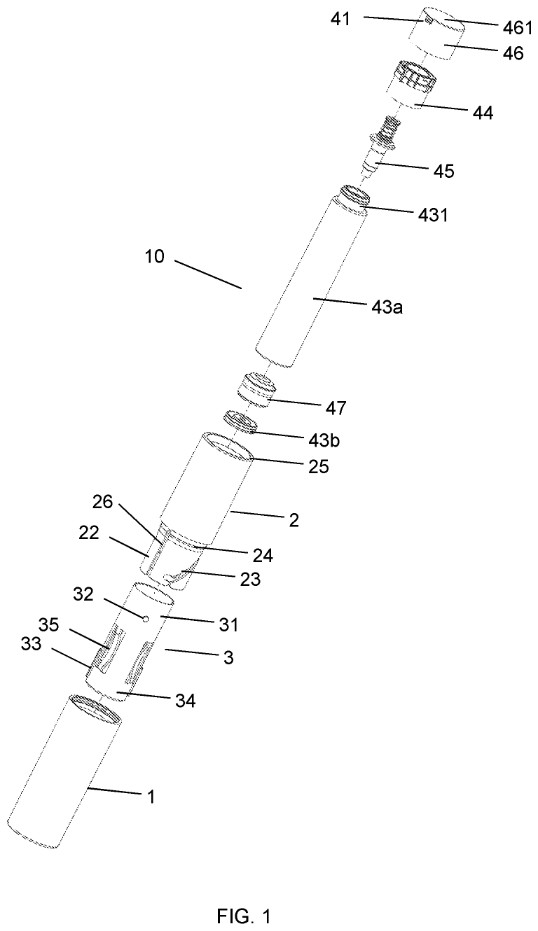

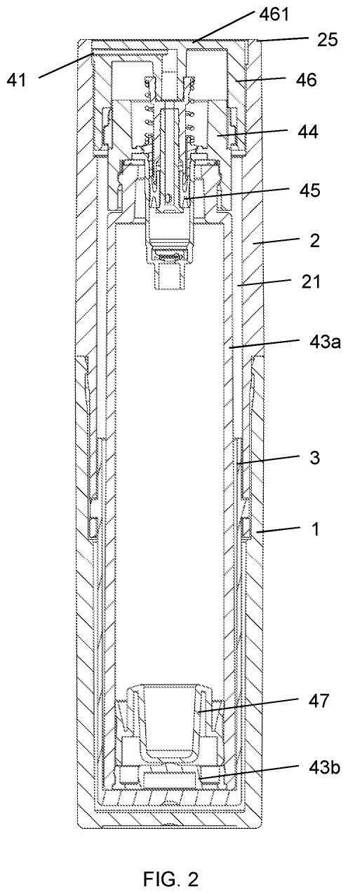

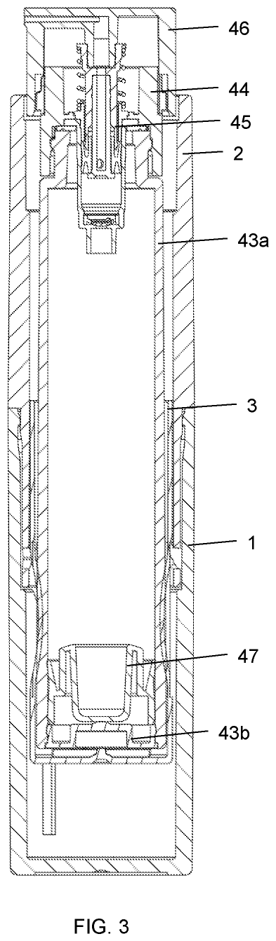

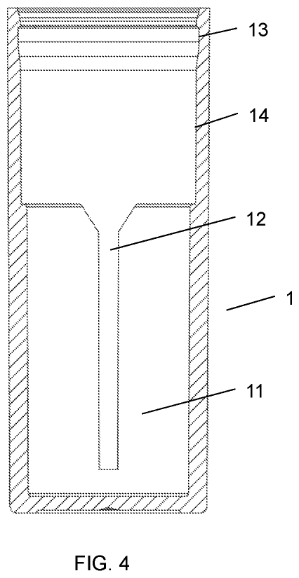

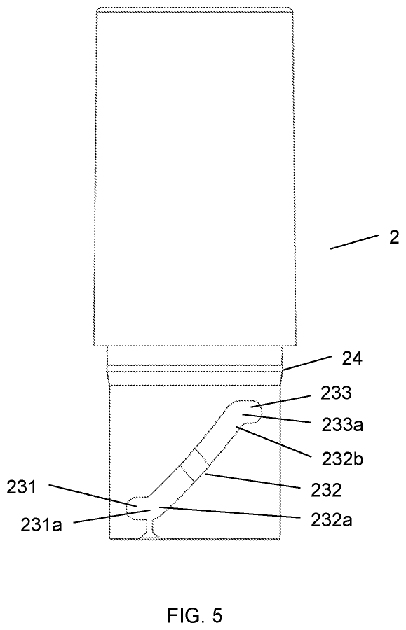

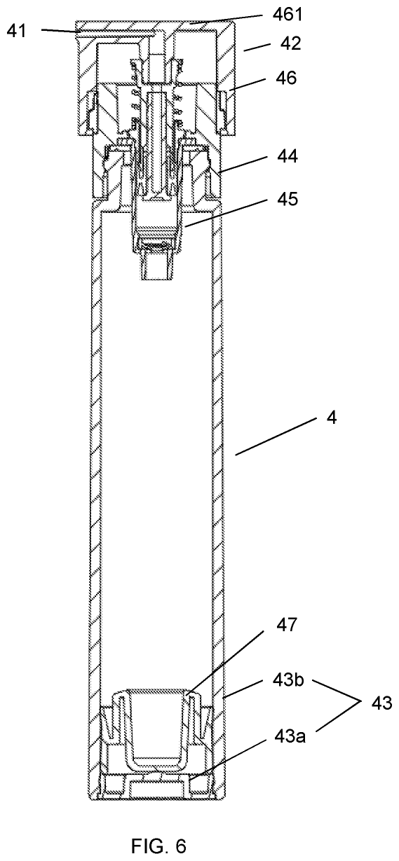

As illustrated in FIGS. 1 to 6, the present embodiment of the refillable dispenser case 10 comprises an outer base 1, an outer cover 2, a cup 3 and a bottle 4.

The outer base 1 is rotatably connected to the outer cover 2. Each of the outer base 1 and the outer cover 2 has a tubular interior 11, 21 which are interconnected with each other.

The cup 3 is received within and slidably coupled to the outer base 1. In this embodiment, the outer base 1 is provided with two circumferentially spaced guiding grooves 12, each of the guiding grooves 12 engages with a corresponding guiding rib 33 protruded outwards from a lower portion 34 of the cup 3, so that the cup 3 slides upwards and downwards relative to the outer base 1 along the guiding grooves 12.

The outer cover 2 has a lower portion 22 which extends within the outer base 1 and sleeves around an upper portion 31 of the cup 3, and the lower portion 22 of the outer cover 2 is provided with two circumferentially spaced slanted sliding grooves 23, each of the slanted sliding grooves 23 engages with a corresponding protrusion 32 protruded outwards from the upper portion 31 of the cup 3. Each of the slanted sliding grooves 23 comprises a lower horizontal section 231, a slanting section 232 and an upper horizontal section 233, a first end 231a of the lower horizontal section 231 communicates with a lower end 232a of the slanting section 232, and a first end 233a of the upper horizontal section 233 communicates with an upper end 232b of the slanting section 232. The lower portion 22 of the outer cover 2 has an annular rib 24 for snap engagement with an annular groove 13 in an inner surface 14 of the outer base 1 so as to prevent the outer cover 2 from disengaging from the outer base 1. To provide more flexibility and to facilitate assembly of the lower portion 22 of the outer cover 2 with the outer base 1, a longitudinal slot 26 is provided at the lower portion 22 of the outer cover 2.

The bottle 4 is inserted in the cup 3 and having a dispensing outlet 41 at an upper portion 42 thereof. In this embodiment, the bottle 4 is releasably inserted in the cup 3 so as to facilitate replacement of the bottle 4. The cup 3 is provided with four circumferentially spaced elastic arc portions 35 which are convex inwards so as to releasably retain the bottle 4 in the cup 3. In other embodiments not shown in the figures, the bottle 4 may be releasably retained in the cup 3 by means of other retaining mechanisms in the art, such as snap fitment, releasable friction fit, magnetic engagement and the like.

In this embodiment, the bottle 4 comprises a bottle body 43 formed by an upper bottle body 43a and a lower bottle cover 43b, a collar 44, a pump engine 45, an actuator 46 and a piston 47. The bottle body 43 stores cosmetic contents to be dispensed via the dispensing outlet 41. An upper end 431 of the bottle body 43 is coupled to the collar 44 in which the pump engine 45 is disposed. The dispensing outlet 41 is disposed in the actuator 46 and communicates with the pump engine 45. The actuator 46 cooperates with the pump engine 45 so that actuating the actuator 46 by means of pressing the actuator 46 activates the pump engine 45 to pull the piston 47 disposed in the bottle body 43 upwards to discharge contents stored in the bottle body 43 via the dispensing outlet 41. The operation of the actuator 46, the pump engine 45 and the piston 47 is well known in the art and so the details are not repeated herein. In other embodiments, the bottle body 43 may also store other contents such as medication, disinfectant and the like in various forms such as liquid, cream, powder, gel and so forth. Furthermore, other types of dispensing mechanisms may be used instead of the pump engine 45 and the piston 47, such as airless pumps, vaporizers and so forth.

The operation of the present embodiment is as follows: When the refillable dispenser case 10 is not in use, the cup 3 is at the retracted position at which the dispensing outlet 41 of the bottle 4 is not exposed from the outer cover 2. At the retracted position, each of the two protrusions 32 of the cup 3 is at the lower horizontal section 231 of the corresponding slanted guiding groove 23, and the cup 3 is rested at the bottom of the outer base 1. At this time, the top surface 461 of the actuator 46 of the bottle 4 flushes with the top end 25 of the outer cover 2.

When the user needs to dispense the contents in the bottle 4, the user rotates the outer base 1 relative to the outer cover 2 in a first direction which corresponds to the direction towards which the slanted sliding grooves 23 are slanted upwards, thus simultaneously rotates the cup 3 and drives each of the protrusions 32 of the cup 3 to move upwards along the slanting section 232 of the corresponding slanted sliding groove 23, and thereby driving the cup 3 to slide axially upwards relative to the outer base 1; the user keeps rotating the outer base 1 relative to the outer cover 2 until each of the protrusions 32 reaches the upper end 232b of the slanting section 232 and slides into the upper horizontal section 233 of the corresponding slanted sliding groove 23. When each of the protrusions 32 reaches the end of the upper horizontal section 233 of the corresponding slanted sliding groove 23, no more rotation in the first direction is possible. At this time, the cup 3 is at the extended position at which the dispensing outlet 41 of the bottle 4 is protruded outward from the outer cover 2. Pressing the actuator 46 activates the pump engine 45 to pull the piston 47 disposed in the bottle body 43 upwards to discharge the contents stored in the bottle body 43 via the dispensing outlet 41.

After the user finishes dispensing the contents in the bottle 4, the user rotates the outer base 1 relative to the outer cover 2 in a second direction which is opposite to the first direction, and thus simultaneously rotates the cup 3 and drives each of the protrusions 32 of the cup 3 to move downwards along the slanting section 232 of the corresponding slanted sliding groove 23, and thereby driving the cup 3 to slide axially downwards relative to the outer base 1; the user keeps rotating the outer base 1 relative to the outer cover 2 until each of the protrusions 32 reaches the lower end 232a of the slanting section 232 and slides into the lower horizontal section 231 of the corresponding slanted sliding groove 23. When each of the protrusions 32 reaches the end of the lower horizontal section 231 of the corresponding slanted sliding groove 23, no more rotation in the second direction is possible. At this time, the cup 3 returns to the retracted position.

If the user wishes to replace the bottle 4 with another bottle, the user may simply rotates the outer base 1 relative to the outer cover 2 in the first direction to move the cup 3 to the extended position, and then simply pull the actuator 46 of the bottle 4 outward to overcome the retaining force of the elastic arc portions 35 of the cup 3 to remove the bottle 4 from the cup 3. To insert the bottle 4 into the cup 3, just push the bottle 4 into the cup 3 and the bottle 4 is retained in position by the elastic arc portions 35.

The embodiments described above are exemplary embodiments of the present invention. It is understood that the present invention should not be limited to the embodiments as described. Any changes, modifications, replacements, combinations and simplification without deviating from the essence and principle of the present invention should be considered alternative configurations that are equally effective and should also fall within the scope of protection of the present invention.

What is claimed is:

1. A refillable dispenser case comprising:
an outer base rotatably connected to an outer cover;
a cup received within and slidably coupled to the outer base;
the outer cover has a lower portion which extends within the outer base and sleeves around an upper portion of the cup, and the lower portion of the outer cover is provided with at least one slanted sliding groove, each of the at least one slanted sliding groove engages with a corresponding protrusion protruded outwards from the upper portion of the cup;
a bottle inserted in the cup and having a dispensing outlet at an upper portion thereof;
rotation of the outer base relative to the outer cover simultaneously rotates the cup and drives the protrusion of the cup to move along the corresponding slanted sliding groove and thereby driving the cup to slide axially relative to the outer base between a retracted position at which the dispensing outlet of the bottle is not exposed from the outer cover and an extended position at which the dispensing outlet of the bottle is protruded outward from the outer cover.

2. The refillable dispenser case as in claim 1, wherein the outer base is provided with at least one guiding groove, each of the at least one guiding groove engages with a corresponding guiding rib protruded outwards from a lower portion of the cup.

3. The refillable dispenser case as in claim 1, wherein the bottle is releasably inserted in the cup.

4. The refillable dispenser case as in claim 3, wherein the cup is provided with at least one elastic arc portion which is convex inwards so as to releasably retain the bottle in the cup.

5. The refillable dispenser case as in claim 1, wherein each of the slanted sliding grooves comprises a lower horizontal section, a slanting section and an upper horizontal section, a first end of the lower horizontal section communicates with a lower end of the slanting section, and a first end of the upper horizontal section communicates with an upper end of the slanting section.

6. The refillable dispenser case as in claim 1, wherein the each of the outer cover and the outer base has a tubular interior which are interconnected with each other.

7. The refillable dispenser case as in claim 1, wherein the lower portion of the outer cover has an annular rib for snap engagement with an annular groove in an inner surface of the outer base.

8. The refillable dispenser case as in claim 1, wherein the bottle comprises a bottle body, an upper end of the bottle body is coupled to a collar in which a pump engine is disposed; the dispensing outlet is disposed in an actuator and communicates with the pump engine; the actuator cooperates with the pump engine so that actuating the actuator activates the pump engine to pull a piston disposed in the bottle body upwards to discharge contents stored in the bottle body via the dispensing outlet.

9. The refillable dispenser case as in claim 8, wherein a top surface of the actuator flushes with a top end of the outer cover at the retracted position.

10. The refillable dispenser case as in claim 1, wherein a longitudinal slot is provided at the lower portion of the outer cover.
